(19) United States
(12) Patent Application Publication
(10) Pub. No.: US 2011/0040017 A1
(43) Pub. Date: Feb. 17, 2011

(54) POLYPHENYLENE SULFIDE (PER)FLUOROPOLYMER MATERIALS AND PROCESS FOR PREPARATION AND USE THEROF

(75) Inventor: Dieter Lehmann, Coswig (DE)

Correspondence Address: GREENBLUM & BERNSTEIN, P.L.C., 1950 ROLAND CLARKE PLACE, RESTON, VA, 20191, US

(73) Assignee: LEIBNIZ-INSTITUT FUER POLYMERFORSCHUNG DRESDEN E.V., Dresden (DE)

(21) Appl. No.: 12/673,362

(22) PCT Filed: Aug. 8, 2008
(86) PCT No.: PCT/EP2008/060467

§ 371 Date: Feb. 12, 2010

(30) Foreign Application Priority Data
Aug. 13, 2007 (DE) 10 2007 038 929.0

(51) Int. Cl. C08L 81/04

(52) U.S. Cl. 524/502; 525/189

(57) ABSTRACT

The invention relates to polyphenylene sulfide (per)fluoropolymer materials, which can be used, for example, as tribomaterials. In particular, the present invention relates to polyphenylene sulfide (per)fluoropolymer materials that have an improved tribological behavior. The polyphenylene sulfide (per)fluoropolymer materials comprise a polyphenylene sulfide polymer matrix (PPS polymer matrix) with modified (per)fluoropolymer particles distributed therein in a (poly) disperse manner, which are present bonded to the PPS polymer matrix via chemical couplings. The present invention also relates to a method in which polyphenylene sulfide (PPS) with thiol groups and/or thiolate groups is reactively compounded in a melt with one or more modified (per)fluoropolymer (micro/nano) powders in a single-step or multi-step manner.

### FIELD OF THE INVENTION

The invention relates to the field of chemistry and relates to polyphenylene sulfide (per)fluoropolymer materials, which can be used, for example, as tribomaterials for, e.g., friction bearings, gear wheels or as tribologically stressed material in the aerospace field, in the automotive field, e.g., for ball bearing shells in hinged joints, as well as in technology in components with high requirements (e.g., as ball bearing cages) and tribologically stressed running surfaces of sports equipment. The invention also relates to a method for the production thereof.

### RELATED ART

Polyphenylene sulfides (PPS) as high-performance materials are offered commercially modified with different fillers and reinforcing agents. In the case of filled and reinforced PPS, these fillers and reinforcing agents are physically incorporated in the PPS polymer matrix according to the prior art.

The materials with special tribological properties include (per)fluoropolymers, such as, e.g., polytetrafluoroethylene (PTFE) and FEP.

In known methods for the modification of PTFE, a chemical activation of PTFE is achieved with (1^{st}) sodium amide in liquid ammonia and with (2^{nd}) organometallic compounds in aprotic inert solvents. Improved interfacial interactions can be achieved through these modifications reactively or via adsorptive forces only.

Furthermore, the radiation chemical modification of (per)fluoropolymers in the absence or in the presence of agents such as, e.g., (atmospheric) oxygen and/or the plasma chemical modification of (per)fluoropolymers and the thermomechanical disintegration of PTFE are known as methods [A. Heger et al., Technologie der Strahlenchemie an Polymeren, Akademie-Verlag Berlin 1990; PTFE-Mikropulver TF9205, Dyneon].

Furthermore, the modification or functionalization of PTFE particles through monomer grafting or coupling with polymers is known (U.S. Pat. No. 5,576,106, DE 198 23 609 A1, DE 103 51 813 A1, DE 103 51 814 A1). Since the melting temperatures during thermoplastic (further) processing (e.g., by extrusion) or during the shaping of PPS are >300° C., the known PTFE modificates cannot be used with aliphatically grafted functional groups and/or polymers due to the known low thermal stability of these aliphatic compounds for coupling with PPS under melt processing conditions.

A compatibilization of PTFE with PPS, within the scope of this invention, is understood to mean a chemical coupling, and has not been described so far.

### SUMMARY OF THE INVENTION

The aim of the present invention is to disclose polyphenylene sulfide (per)fluoropolymer materials that have an improved tribological behavior and a simple and cost-effective method for the production and use thereof.

The aim is attained through the invention disclosed in the claims. Advantageous embodiments are the subject matter of the subordinate claims.

### DETAILED DESCRIPTION OF THE INVENTION

The polyphenylene sulfide (per)fluoropolymer materials according to the invention are composed of a material produced via melt modification from a polyphenylene sulfide polymer matrix (PPS polymer matrix) with modified (per)fluoropolymers distributed therein in a (poly) disperse manner, wherein the modification of the (per)fluoropolymers is realized with functional groups, and the modified (per)fluoropolymer particles present are bonded to the PPS polymer matrix via chemical couplings, wherein the chemical couplings have taken place during the melt modification through reaction with already present functional reactive groups of the (per)fluoropolymers and/or with functional groups of persistent (long-lived) perfluorocarbon (peroxy) radicals of the (per)fluoropolymers produced during the melt modification and/or with functional (re)active groups of the (per)fluoropolymers produced during the melt modification.

Advantageously, the (per)fluoropolymers are present chemically coupled to the PPS polymer matrix via thio ether bond(s) and/or thiol ester bond(s).

Likewise advantageously, linear and/or branched polymers are present in the PPS matrix.

Furthermore advantageously, polytetrafluoroethylene (PTFE) and/or poly(tetrafluoroethylene-co-hexafluoropropylene) (FEP) and/or poly(ethylene-co-tetrafluoroethylene) (ETFE) and/or polychlorotrifluoroethylene (PCTFE) and/or poly(tetrafluoroethylene-co-perfluoroalkyl vinyl ether) (TFA or PFA) are present as (per)fluoropolymers.

And also advantageously the chemically coupled (per)fluoropolymers acting as nucleation agents/ crystal nucleation agents are present finely distributed in the PPS polymer matrix.

With the method according to the invention for producing polyphenylene sulfide (per)fluoropolymer materials, polyphenylene sulfide (PPS) with thiol groups and/or thiolate groups are reactively compounded in a melt with one or more modified (per)fluoropolymer (micro/nano) powders in a single-step or multi-step manner, wherein further thermoplastic or thermosetting (high-performance) polymers and/or fillers and/or reinforcing agents and/or additives can be added.

Advantageously, modified (per)fluoropolymer powders with olefinically unsaturated groups and/or with carboxylic acid groups and/or carboxylates and/or carboxylic halide groups, even more advantageously with perfluoroalkylene groups or the carboxylic halide groups in the form of carboxylic fluoride groups are used.

Likewise advantageously, modified (per)fluoropolymer powders with persistent (long-lived) perfluorocarbon (peroxy) radicals, even more advantageously modified (per)fluoropolymer powders with persistent (long-lived) perfluorocarbon (peroxy) radicals are used, which have been produced through radiation chemical modification of (per)fluoropolymer (micro/nano) powder particles under the influence of oxygen.

Furthermore advantageously, (per)fluoropolymers with thermally unstable functional groups are used.

And also advantageously polytetrafluoroethylene (PTFE) and/or poly(tetrafluoroethylene-co-hexafluoropropylene) (FEP) and/or poly(ethylene-co-tetrafluoroethylene) (ETFE) and/or polychlorotrifluoroethylene (PCTFE) and/or poly(tetrafluoroethylene-co-perfluoroalkyl vinyl ether) (TFA or PFA) are used as modified (per)fluoropolymer (micro/nano) powder, wherein even more advantageously radiation chemically degraded PTFE and even more advantageously PTFE radiation chemically degraded under the influence of oxygen is used as modified (per)fluoropolymer (micro/nano) powder.

Advantageously a PTFE radiation chemically degraded and modified with at least 20 kGy, even more advantageously with at least 100 kGy, is used as radiation chemically degraded PTFE.

It is also advantageous if a thermally/thermomechanically modified (per)fluoropolymer (micro/nano) powder particle is used as modified (per)fluoropolymer (micro/nano) powder.

It is likewise advantageous if PPS with reactive thiol groups and/or thiolate groups in linear and/or branched form is used.

It is furthermore advantageous if PPS polymers with a low number of thiol groups and/or thiolate groups are used in a ratio to thiol group-rich and/or thiolate group-rich PPS polymers of 99:1 to 1:99.

It is also advantageous if PPS polymers with ≦1% thiol groups on the PPS chain ends are used as PPS polymers with a low proportion of thiol groups and/or thiolate groups.

It is also advantageous if PPS polymers with >1% thiol groups on the PPS chain ends are used as PPS polymers with a high proportion of thiol groups and/or thiolate groups.

It is likewise advantageous if 1 to 99% by weight, even more advantageously if 5 to 50% by weight, and again more advantageously if 10 to 30% by weight of modified (per)fluoropolymer (micro/nano) powder particles, based on the PPS polymer, are used.

It is furthermore advantageous if further thermoplastic or thermosetting (high-performance) polymers and/or fillers and/or reinforcing agents are added before or during or after the reactive compounding.

It is also advantageous if the reactive compounding is carried out in a melt mixer and/or in a kneader and/or in a twin-screw extruder or multi-shaft extruder and/or in a planetary gear extruder.

It is also advantageous if the reactive compounding is carried out at melt processing temperatures of at least the or above the melting temperature of the PPS material.

Advantageously the reactive compounding is carried out at melt processing temperatures of at least the or above the melting temperature of the (per)fluroropolymer material.

It is also advantageous if a further reactive conversion is carried out during and/or after the reactive compounding.

Likewise advantageously, the modified (per)fluoropolymer (micro/nano) powder is added to the melt during the compounding at one or more metering points.

It is furthermore advantageous if the modified (per)fluoropolymer (micro/nano) powder is used as a mixture of unmodified and modified (per)fluoropolymers.

The use according to the invention of polyphenylene sulfide (per)fluoropolymer materials is carried out as a compact substance and/or as an addition/constituent of friction bearings and/or in oleophobic and/or hydrophobic or partial materials or compact materials equipped therewith and/or in molded parts and/or as a surface modification component in (slip) films or as a coating and/or in low-friction films and/or as a blend component and/or as an additive.

Advantageously the polyphenylene sulfide (per)fluoropolymer materials are used for further processing to form a thermoplastic melt and/or a reactive mass and/or a dispersion.

Through the present invention it is possible to disclose chemically coupled polyphenylene sulfide (per)fluoropolymer materials via a reactive conversion in a melt with a stable processing morphology and a finely dispersed (per)fluoropolymer component in the PPS matrix component, which can be processed to form components that have sliding friction values comparable to PTFE and low wear coefficients. Components of this type thereby achieve a higher service life.

The compounds of PPS and (per)fluoropolymer according to the invention are obtained through reactive conversion in a melt mixer, for example. Thereafter the modified (per)fluoropolymer component is not only present in the PPS matrix homogenously distributed, it is also compatibilized, i.e., chemically coupled, with the PPS matrix component through chemical coupling. This leads to the advantageous properties of the materials according to the invention.

The proof of the chemical coupling is provided by the separation of the free PPS matrix component from the insoluble (per)fluoropolymer component, according to which according to the invention the pure (per)fluoropolymer is no longer obtained, but a (per)fluoropolymer product that has PPS polymer chains chemically coupled on the surface and modified after the separation process.

Through processing of the PPS matrix materials with the modified (per)fluoropolymer (micro/nano) powder, homogenously dispersed compounds can be produced directly, in which not as previously known the (per)fluoropolymer component is present only incorporated as an insoluble and incompatible secondary component. The (per)fluoropolymer component according to the invention is now in direct interaction with the PPS matrix polymer via covalently bonded PPS polymer chains, whereby a homogenous distribution and a stable processing morphology are achieved. Via mechanical forces, such as, e.g., under sliding friction conditions, the (per)fluoropolymer particles, in contrast to physical mixtures and incorporations, can no longer simply be rubbed out of the matrix material due to the chemical bond via the PPS polymer chains.

In addition to the concentration of reactive groups in the PPS and in the (per)fluoropolymer (micro/nano) powder, the melt processing conditions also have an important influence on the coupling reactions, since the reactive groups can react only in direct contact with one another. The best possible intermixing of the reaction components must therefore be realized.

Reactive groups in the PPS are the thiol groups and/or thiolate groups of the linear or branched PPS polymers, which are preferably present as terminal groups. The reactive groups in the (per)fluoropolymer are olefinically unsaturated double bonds, which are capable of addition with the thiol groups and/or thiolate groups in the PPS. Furthermore, during the reactive conversion in the melt, the melt processing conditions can be adjusted such that through elimination/elimination reactions such reactive olefinic double bonds are formed in the (per)fluoropolymer component. To this end hydrogen halide and preferably hydrogen fluoride is separated and/or carboxylic groups present react with the separation of CO₂ and simultaneous or subsequent elimination of hydrogen fluoride, and in-situ reactive coupling centers are thus formed.

A further coupling reaction is the reaction of the thiol groups and/or thiolate groups in the PPS with carbonyl fluoride groups in the (per)fluoropolymer, which form, e.g., during the radiation modification, e.g., with electron and/or gamma rays in the presence of oxygen.

A further possibility is the conversion of persistent/long-lived perfluoro(peroxy) radical centers in the (per)fluoropolymer to reactive coupling groups in melt/under melt processing conditions, wherein it cannot be ruled out that these radicals can also react directly with the PPS with coupling.

Persistent/long-lived perfluoro-(peroxy) radical centers of this type in the (per)fluoropolymer have formed during the polymerization reaction of the (per)fluoropolymer or can also be produced in addition through radiation chemical and/or plasma chemical modification of (per)fluoro polymers.

In all, with the polyphenylene sulfide (per)fluoropolymer materials according to the invention, the (per)fluoropolymer particles are compatibilized, i.e., rendered compatible with the PPS matrix via chemical bonds.

In the production of the polyphenylene sulfide (per)fluoropolymer materials according to the invention, i.e., during the melt processing of the (per)fluoropolymer particles with polyphenylene sulfide, through correspondingly large shearing, a separation and intermixing of the starting materials is achieved, so that the functional groups in the (per)fluoropolymer particle, most of which are sterically shielded by (per)fluoropolymer chains, are exposed. Through this measure the already present and/or also produced functional groups and/or persistent (long-lived) perfluorocarbon (peroxy) radicals of the (per)fluoropolymers come into direct contact with the functional groups of the polyphenylene sulfide. The chemical bonding/coupling of the (per)fluoropolymer (particle) with the polyphenylene sulfide can take place only in direct contact with one another.

The (per)fluoropolymer (micro/nano) powder can either be melted together with the PPS component or it can be added into the PPS melt directly. The materials according to the invention surprisingly form directly in the melt reaction, wherein advantageously materials that can be further processed directly are obtained.

The reactive conversion in the melt is carried out at PPS processing temperatures. For the production of the materials according to the invention, all PPS materials can be used in pure form and/or also filled and/or reinforced. Likewise further polymers can be added. These materials can be used as starting mixture and/or added during the melt processing and/or in a subsequent step, for example, a blend formation. The production method can be realized as a single-step or multi-step method.

The materials produced can be used as a compact substance and/or as an addition/constituent of friction bearings and/or in oleophobic and/or hydrophobic or partial or compact materials equipped therewith and/or in molded parts and/or as surface modification components, e.g., in slip films or low-friction films and/or as a coating and/or as a blend component and/or as an additive, e.g., in anti-friction varnishes.

The invention is explained in more detail below based on several exemplary embodiments.

### Example 1

In a ZSK30 twin screw extruder (Werner & Pfleiderer), X kg/h PPS (Fortron, Ticona) and Y kg/h PTFE (see Table 1) are metered into the funnel. The twin screw extruder is operated at the temperature profile shown below and a speed of 200 rpm. The melt strand is granulated after the water-bath cooling.

The material obtained is further processed through injection molding to form semi-finished products and test pieces, from which the test pieces are produced and on which the following properties were determined.

TABLE 1
Parameters for producing the PPS + PTFE cc materials
ZSK-30-41 L/D

| | | X kg/h PPS | |
|---|---|---|---|
| Test | Material | (natural, Ticona) | Y kg/h PTFE |
| PPS | PPS + 20TF2025(500) | 6.4 kg/h | 1.6 kg/h TF2025 |
| 1 | cc | PPS Fortron | (electron-irradiated with |
| | | 0205 P4 | 500 kGy) |
| PPS | PPS + 30TF2025(500) | 5.6 kg/h | 2.4 kg/h TF2025 |
| 2 | cc | PPS Fortron | (electron-irradiated with |
| | | 0205 P4 | 500 kGy) |
| PPS | PPS + 20TF9205 cc | 6.4 kg/h | 1.6 kg/h TF9205 |
| 3 | | PPS Fortron | |
| | | 0205 P4 | |

cc . . . chemically coupled/compatibilized
TF2025 and TF9205 . . . manufactured by Dyneon
Processing temperature: 290-330-330-330-300-280-D:270° C.
Speed: 200 rpm
Throughput: 8 kg/h materials, PPS, natural, Fortron, Ticona)—see Table
2 × deaeration/degasification, granulation nozzle, water-bath cooling, granulator

The material characteristic values from the physical test are shown in Table 2. The materials produced exhibit only a slight decrease of the modulus of elasticity values, despite the addition of the “soft” PTFE in the order of magnitude of 20 and 30% by weight. The values for tensile strength are analogous. The values for impact strength and notched impact strength are surprising. Through the chemical coupling/compatibilization, PTFE does not act as a foreign substance but as a type of impact strength modifier.

TABLE 2
Mechanical characteristic values of the PPS or PPS + PTFE
cc materials (test approx. 240 h after production of the test pieces)

| | | E₁ | σ_{M} | ε_{M} | σ_{B} | ε_{B} | a_{cU} | a_{cA} |
|---|---|---|---|---|---|---|---|---|
| Test | Material | [GPa] | [MPa] | [%] | [MPa] | [%] | [kJ/m²] | [kJ/m²] |
| PPS | PPS sack goods | 3.73 | 61.2 | 1.7 | 60.5 | 1.7 | 21.8 | 2.3 |
| 0 | (comparison) | | | | | | | |
| PPS | PPS + 20TF2025 | 3.40 | 56.1 | 2.0 | 55.4 | 2.0 | 25.3 | 3.3 |
| 1 | (500) cc | | | | | | | |
| PPS | PPS + 20TF2025 | 3.03 | 50.6 | 2.5 | 50.5 | 2.5 | 20.6 | 3.0 |
| 2 | (500) cc | | | | | | | |
| PPS | PPS + 20TF9205 cc | 3.35 | 53.0 | 2.0 | 52.0 | 2.0 | 27.5 | 3.1 |
| 3 | | | | | | | | |

The tribological properties of the PPS+PTFE cc materials exhibit a sliding friction behavior similar to PTFE. Compared to pure PPS, a reduction in the wear values to 27 to 30% with the addition of 20% by weight of PTFE and to 18 to 21% with the addition of 30% by weight PTFE are established.

1. A polyphenylene sulfide (per)fluoropolymer material comprising: a material produced via melt modification of a polyphenylene sulfide (PPS) polymer matrix with modified (per)fluoropolymers distributed therein in a (poly) disperse manner, wherein
the (per)fluoropolymers are modified with functional groups, and
the modified (per)fluoropolymer particles are bonded to the PPS polymer matrix via chemical couplings, wherein
the chemical couplings have taken place during the melt modification through reaction with functional reactive groups of the (per)fluoropolymers and/or with functional groups of perfluorocarbon (peroxy) radicals of the (per)fluoropolymers produced during the melt modification and/or with functional (re)active groups of the (per)fluoropolymers produced during the melt modification.

2. The material according to claim 1, in which the (per)fluoropolymers are chemically coupled to the PPS polymer matrix via thio ether bond(s) and/or thiol ester bond(s).

3. The material according to claim 1, in which linear and/or branched polymers are present in the PPS polymer matrix.

4. The material according to claim 1, in which the (per)fluoropolymers are selected from: polytetrafluoroethylene (PTFE) and/or poly(tetrafluoroethylene-co-hexafluoropropylene) (FEP) and/or poly(ethylene-co-tetrafluoroethylene) (ETFE) and/or polychlorotrifluoroethylene (PCTFE) and/or poly(tetrafluoroethylene-co-perfluoroalkyl vinyl ether) (TFA or PFA).

5. The material according to claim 1, in which the chemically coupled (per)fluoropolymers act as nucleation agents/ agents or crystal nucleation agents and are finely distributed in the PPS polymer matrix.

6. A method for producing polyphenylene sulfide (per)fluoropolymer materials, comprising:
reactively compounding a polyphenylene sulfide (PPS) polymer with thiol groups and/or thiolate groups in a melt with one or more modified (per)fluoropolymer (micro/nano) powders in a single-stage or multi-stage manner, wherein further thermoplastic or thermosetting (high-performance) polymers and/or fillers and/or reinforcing agents and/or additives can be added.

7. The method according to claim 6, in which
PPS polymers with reactive thiol groups and/or thiolate groups are in linear and/or branched form, and/or
PPS polymers with a low number of thiol groups and/or thiolate groups are present in a ratio to thiol group-rich and/or thiolate group-rich PPS polymers of 99:1 to 1:99, and/or
PPS polymers with ≦1% thiol groups on the PPS chain ends are present as PPS polymers with a low proportion of thiol groups and/or thiolate groups or PPS polymers with >1% thiol groups on the PPS chain ends are present as PPS polymers with a high proportion of thiol groups and/or thiolate groups.

8. The method according to claim 6, in which the one or more modified (per)fluoropolymer (micro/nano) powders are selected from
(per)fluoropolymer (micro/nano) powder with olefinically unsaturated groups and/or with carboxylic acid groups and/or carboxylates and/or carboxylic halide groups, optionally in the form of carboxylic fluoride groups, and/or with perfluoroalkylene groups, and/or with persistent (long-lived) perfluorocarbon (peroxy) radicals, which optionally have been produced through radiation chemical modification of (per)fluoropolymer (micro/nano) powder particles under the influence of oxygen, and/or as (per)fluoropolymers with thermally unstable functional groups, and/or as polytetrafluoroethylene (PTFE) and/or poly(tetrafluoroethylene-co-hexafluoropropylene) (FEP) and/or poly(ethylene-co-tetrafluoroethylene) (ETFE) and/or polychlorotrifluoroethylene (PCTFE) and/or poly(tetrafluoroethylene-co-perfluoroalkyl vinyl ether) (TFA or PFA), and/or as a thermally/thermomechanically modified (per)fluoropolymer (micro/nano) powder, and
are reactively compounded in melt in a single-stage or multi-stage manner, wherein further thermoplastic or thermosetting (high-performance) polymers and/or fillers and/or reinforcing agents and/or additives can be added.

9. The method according to claim 6, in which the modified (per)fluoropolymer (micro/nano) powder is radiation chemically degraded PTFE, optionally PTFE radiation chemically degraded under the influence of oxygen, and/or optionally PTFE radiation chemically degraded and modified with at least 20 kGy.

10. The method according to claim 6, in which the modified (per)fluoropolymer (micro/nano) powder comprises 1 to 99% by weight, based on the PPS polymer.

11. The method according to claim 6, in which further thermoplastic or thermosetting (high-performance) polymers and/or fillers and/or reinforcing agents are added before or during or after the reactive compounding.

12. The method according to claim 6, in which the reactive compounding is carried out in a melt mixer and/or in a kneader and/or in a twin-screw extruder or multi-shaft extruder and/or in a planetary gear extruder.

13. The method according to claim 6, in which the reactive compounding is carried out at a melt processing temperature of at least the or above the melting temperature of the PPS material and/or of the (per) fluoropolymer material.

14. The method according to claim 6, in which a further reactive conversion is carried out during and/or after the reactive compounding.

15. The method according to claim 6, in which the modified (per)fluoropolymer (micro/nano) powder is added to the melt during the compounding at one or more metering points.

16. The method according to claim 6, in which the modified (per)fluoropolymer (micro/nano) powder is used as a mixture of unmodified and modified (per)fluoropolymers.

17. A method for producing as a compact substance and/or an addition/constituent of friction bearings and/or oleophobic and/or hydrophobic or partial materials or compact materials equipped with the polyphenylene sulfide (per)fluoropolmer materials according to claim 1 and/or molded parts and/or a surface modification component in (slip) films or a coating and/or low-friction films and/or a blend component and/or an additive, comprising:
forming or adding or combining or equipping said materials with the polyphenylene sulfide (per)fluoropolmer materials according to claim 1.

18. The method according to claim 17, further comprising:
processing the additive further to form a thermoplastic melt and/or a reactive mass and/or a dispersion.

19. The method according to claim 10, wherein the modified (per)fluropolymer (micro/nano) powder comprises 5 to 50% by weight, based on the PPS polymer.

20. The method according to claim 19, wherein the modified (per)fluropolymer (micro/nano) powder comprises 10 to 30% by weight, based on the PPS polymer.
